(19) United States
(12) Patent Application Publication
(10) Pub. No.: US 2005/0181274 A1
(43) Pub. Date: Aug. 18, 2005

(54) High efficiency horizontal battery

(76) Inventor: Steven Glassman, Marlboro, MA (US)

Correspondence Address: Steven P. Glassman, 21 Fay Court, Marlboro, MA, 01752, US

(21) Appl. No.: 10/781,450

(22) Filed: Feb. 18, 2004

(51) Int. Cl. H01M 2/18; H01M 2/16; H01M 2/38; H01M 10/48

(52) U.S. Cl. 429/136; 429/254; 429/139; 429/81; 429/90

(57) ABSTRACT

A flooded cell type lead-acid battery includes a separator-filter material that is enveloped around a porous electrode, housed in a frame and placed in a cell compartment horizontally from it's opposite electrode. Flow is moved up through a porous electrode assembly using a miniature corrosion resistant pump. The separator filter material allows electrolyte to pass uniformly between electrodes and return from top overflow in a closed loop continuous flow. The resulting economically efficient battery assembly exhibits increased efficiency and cycle life by reducing the layer of hydrogen gas and sulfates coating the electrode reaction, and short-circuiting between vertical cell group.

### BACKGROUND OF THE INVENTION

1. Field of the Invention

The present invention relates to lead-acid battery, and more particularly to a separator filter material thereof, which prevents an internal short-circuit that allows uniform solution flow.

2. Description of the Related Art

In a flood cell-type lead acid battery; a battery separator separates the positive and negative electrodes. Most separators are formed of materials that are porous enough to permit the electrolyte of the battery to reside in the pores of the separator material, thereby allowing current flow between adjacent electrodes, but not allowing contact between electrodes.

The battery separator currently used by most manufactures is polyethylene. This material is formed into sheets and then enveloped around each electrode. The enveloped electrodes are stacked, either against one another or in an alternating pattern with unenveloped electrodes. The resulting stack is then compressed and inserted into the cell compartment of a battery case.

Typically such separators are manufactured to have multiple ribs. The major ribs function to provide proper electrode spacing and to provide a space where free electrolyte can reside. Further, separators having major ribs are more expensive to manufacture in light of the additional separator material that is incorporated into the major ribs.

Separators also hold a paste type electrode, which is widely used, among others, in the lead-acid batteries. When using this type, a synthetic resin porous sheet, and glass mat are used for the separator. Although separators serve to limit the amount of electrode paste that falls to the bottom of cell, operational conditions in car batteries cause paste to fall to bottom of cell. The accumulation of electrolyte mixed with metallic lead causes short-circuiting.

Sulphation is also a constant threat to batteries that are not fully re-charged. A layer of lead sulfate can form in these cells and inhibit the electrochemical reaction that allows you to charge/discharge batteries. Sulphation layers form barrier coats on the lead plates that inhibit there ability to store and dispense energy.

Although there are many different types of separators and electrolytes there use combined in a single efficient, operational battery has not been achieved. Because of these disadvantages, there exists a continuing need for an improved method to separate an electrode group, reduce short circuiting, disperse gas coatings and improve efficiency.

### OBJECTS AND ADVANTAGES

There has been summarized above, rather broadly, the prior art that is related to the present invention in order that the context of the present invention may be better understood and appreciated.

It is an object of the present invention to provide extended cycle life.

It is an object of the present invention to prevent gas coatings on electrodes.

It is an object of the present invention to provide better conversion efficiency.

It is an object of the present invention to reconfigure cell group horizontally.

It is an object of the present invention to move electrolyte in a continuous flow.

These and other objects and advantages of the present invention will become readily apparent as the invention is better understood by reference to the accompanying summary, drawings and the detailed description that follows.

### SUMMARY OF THE INVENTION

The present invention is generally directed to satisfy the needs set forth above and overcoming the limitations and problems identified with prior separators and efficiency of flood cell type lead-acid batteries.

A porous, planar positive electrode configured to sit horizontally opposite its porous negative electrode.

A separator filter media made from polypropylene material surrounds at least one of a positive and a negative material. This configuration results in the following advantages:

Electrolyte between the positive and negative electrodes does not dry up, but stays uniformly saturated.

The separator filter media can be enveloped around porous electrodes and heat sealed at end, therefore this structure can be incorporated into a standard frame sitting horizontally or vertically.

A frame to which the edges of the porous enveloped electrode is attached.

Additional objects and advantages of this invention will be apparent from the following detailed description of preferred embodiments thereof which proceeds with reference to the accompanying drawings.

### BRIEF DESCRIPTION OF THE DRAWINGS

FIG. 1 Provides a perspective view of the porous electrode enveloped with separator material mounted inside a split frame.

FIG. 2 illustrates a drilled or slotted electrode placed inside a polypropylene envelope and heat-sealed at one end.

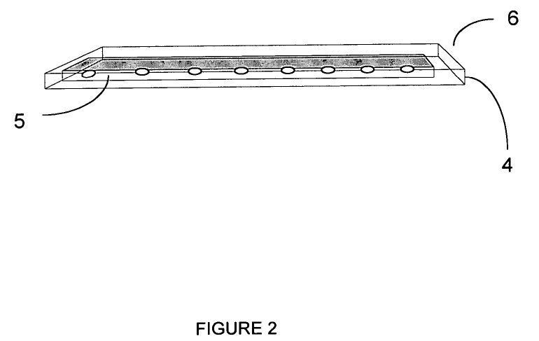

FIG. 3 illustrates a flow diagram of electrolyte passing up through porous electrode, polypropylene envelope and overflowing to pump reservoir.

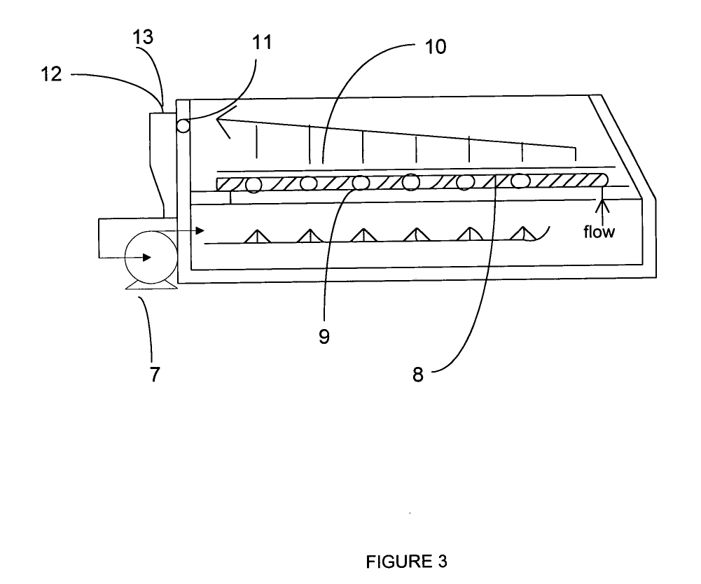

FIG. 4 is a perspective view of an electrode group of porous electrodes enveloped into a polypropylene separator filter, with an optional pump to move electrolyte in a continuous flow.

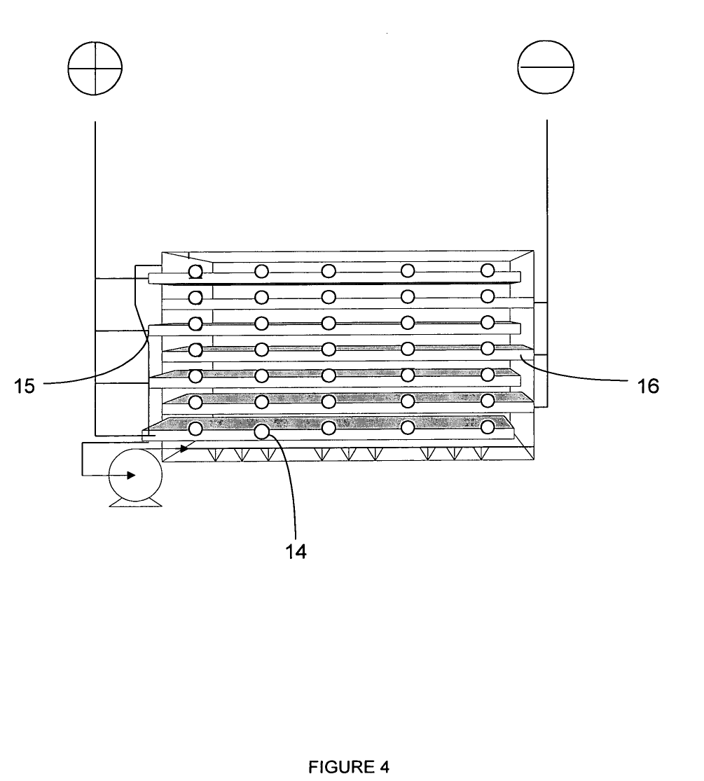

FIG. 5 is a perspective view of battery cell with an outer shell full of absorbent material that acts as secondary containment in case of rupture to primary cell.

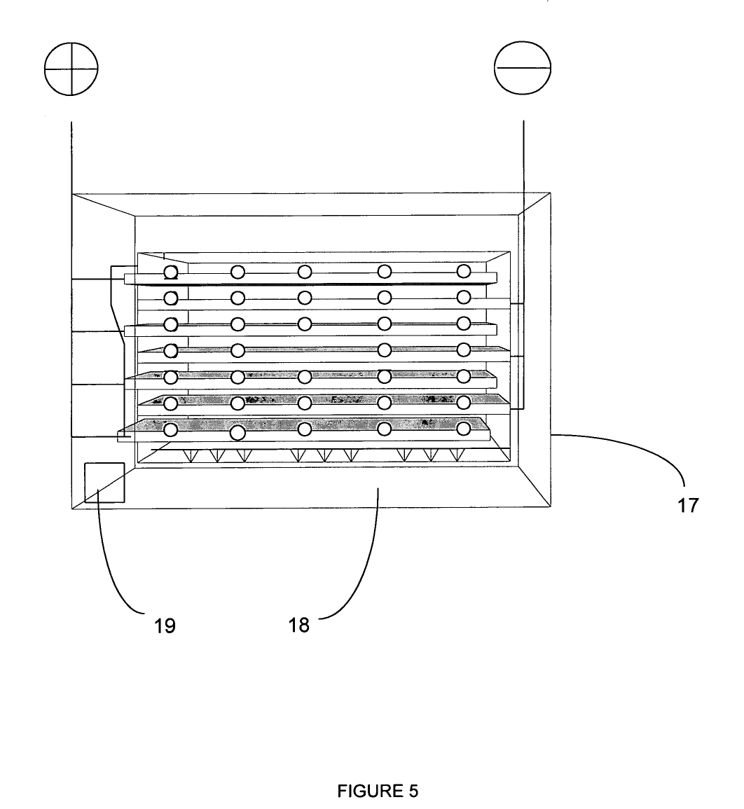

### DETAILED DESCRIPTION OF THE PREFERRED EMBODIMENT

For the purpose of explanation and not limitation, specific details are set forth below in order to provide a thorough understanding of the present invention. However, it will be apparent to one skilled in the art that the present invention maybe practiced in other embodiments that depart from specific details. In other instances, detailed descriptions of well-known methods, hardware, ect. are omitted so as not to obscure the description of the present invention with unnecessary detail.

The present invention is now detailed by referring the drawings and tables.

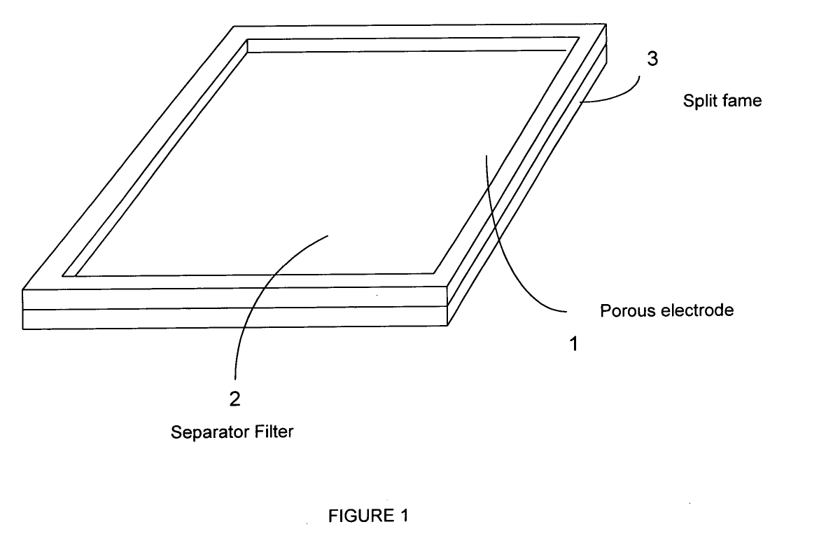

FIG. 1 is a perspective view an electrode 1 is located within separator 2 and held securely in place with plastic or (PP) frame 3. The separator filter media 4 is polypropylene (PP) fiber. This material will be fabricated with one open end to insert porous electrode 5 into envelope. The polypropylene will be 0.25 inches thick with a pore size greater than 200 microns. The envelope will be heat sealed at end 6 and placed into split frame 3 which also can be heat sealed.

Electrolyte will be pumped 7 into base of cell. The entering electrolyte will flow up through separator 8 and porous electrode 9 then flow to top of cell 10 were electrolyte will over flow through check valve 11. The electrolyte will return to a collection tank 12 that serves to circulate electrolyte back through battery cell.

Collection tank 12 acts as a reservoir and can be refilled and vented at top of collection tank 13 above overflow. A sealed cover will be used.

There are preferably a number of passage holes in a flat member electrode 14 that can be offset from its opposite electrode. The positive electrode 15 and negative 16 can be offset for connection purposes. These electrodes can also be set up as an expanded grid (for example, paste type) material. Also battery cell group can also be configured vertically without pump option.

In another preferred embodiment of the present invention, an outer case 17 will act as a secondary containment. This case will hold absorbent material 18 that is compatible with acidic or alkaline electrolyte. There will be an access panel 19 for pump. For safety reasons pump 7 will only run when ignition of car is turned on, also there will be a safety switch that shuts pump off when collection tank top cover 13 is opened.

The above-described embodiments of the present invention are seen to overcome many of the problems identified with prior art. For example coatings on electrodes, short-circuiting, and a vertically configured cell group that occupies a larger footprint with less surface area.

The preferred embodiments described herein are further intended to explain the best mode known of practicing the invention and to enable others skilled in the art to utilize the invention in various embodiments and with various modifications required by their particular applications or uses of the invention. It is intended that appended claims be constructed to include alternate embodiments to the extent permitted by the current art.

1. A porous, corrosion resistant battery separator filter media held inside a frame for use in a lead acid Battery.

2. A lead-acid battery including a porous electrode group which comprises (a) an envelope type separator filter comprising a material made of polypropylene (PP), (b) one of a porous positive and negative electrode surrounded by said envelope and heat sealed together, (c) Both electrodes mounted into separate split plastic or polypropylene frames heat sealed together opposite each other.

3. The battery of claim 1, including any type of porous electrodes and electrolyte enveloped inside separator filter and grouped horizontally or vertically inside a battery cell.

4. A battery cell that uses a 12 vdc miniature pump that draws less than 2 amps of current and produces less than one gallon per min of flow is used to move electrolyte up through enveloped porous electrode assembly.

5. The battery of claim 4, in which a side collection reservoir is mounted that holds electrolyte that flows from top of cell for circulation through pump.

6. The collection reservoir of claim 5, in which inlet flow has a check valve,

7. The collection reservoir of claim 6, in which top portion has removable Pressure release vent style cover where water and electrolyte can be added.

8. A battery outer case that holds chemical absorbent material that acts as secondary containment in case of rupture or spill to primary battery cell.

9. The outer case of claim 9, in which a access panel is mounted to service pump

10. The battery cell that uses a miniature pump of claim 4, further includes a safety switch that turns pump on and off with car ignition.

11. The outer case of claim 9, further includes a sensor that alerts when liquid is detected in secondary containment case.
